(19) United States
(12) Patent Application Publication
(10) Pub. No.: US 2012/0175831 A1
(43) Pub. Date: Jul. 12, 2012

(54) ELASTIC BUSHING, IN PARTICULAR COMPOSITE STEERING BUSHING

(75) Inventor: Jerome Kieffer, Nantes (FR)

(73) Assignee: TRELLEBORG AUTOMOTIVE GERMANY GMBH, HOEHR-GRENZENHAUSEN (DE)

(21) Appl. No.: 13/496,380

(22) PCT Filed: Sep. 7, 2010
(86) PCT No.: PCT/EP10/63088

§ 371 Date: Mar. 15, 2012

(30) Foreign Application Priority Data
Sep. 15, 2009 (DE) 10 2009 041 549.1

(51) Int. Cl. F16F 1/38; B23P 17/04; B60G 11/22

(52) U.S. Cl. 267/292; 29/530

(57) ABSTRACT

An elastic bushing, in particular a composite steering bushing having an inner core and an outer sleeve disposed concentrically with one another, and connected to each other by an elastomer layer. A limiting element between the inner core and the outer sleeve limits the radial displacement of the inner core. The outer sleeve has an inwardly bent end region. In order to provide a cost-effective elastic bushing providing clearance in the radial and axial directions, the inner core is formed with at least one molded recess in the axial direction, the at least one limiting element is positively inserted in the recess, the limiting element is at a distance from the end region in the axial direction, and the end region limits the axial displacement of the inner core.

The present invention relates to an elastic bushing, in particular twist beam rear axle bushing, having an inner core and having an outer sleeve which are arranged concentrically with respect to one another and which are connected to one another by means of an elastomer layer, wherein between the inner core and the outer sleeve there is arranged a limiting element which limits the radial movement of the inner core, and wherein the outer sleeve has an inwardly bent end region. The invention also relates to a method for producing the elastic bushing.

Bushings of said type are used in automobile construction for mounting twist beam rear axles. For this purpose, the bushings are pressed into a receiving lug and fixed by means of a bolt to a bracket connected to the vehicle body. To attain good handling and driving characteristics, a defined amount of play is required in the radial direction and in the axial direction.

DE 196 38 554 A1 discloses an elastic bearing which has an inner core and an outer sleeve which are arranged concentrically with respect to one another. Between the inner core and the outer sleeve there is inserted an elastomer layer. The outer sleeve is bent at its ends so as to form a flange. Inserted between the elastomer layer and the flange at each end is a limiting element which bears against the inner surface of the outer sleeve. Between the limiting element and the inner core there is provided a free space, such that a degree of play is provided in the radial direction. The elastic bearing however has no play in the axial direction, such that the task of providing said axial play must be performed by a bracket by means of which the bushing is connected to the vehicle body. Consequently, the bushing has the disadvantage that an expensive bracket is required for providing play in the axial direction.

DE 30 04 075 A1 discloses an elastic joint which has an inner core and a metallic outer sleeve, wherein the inner core and the outer sleeve are arranged concentrically with respect to one another. Between the inner core and the outer sleeve there is inserted an elastomer body. Two metal rings are attached to the elastomer body, at the end side in each case, for axially fixing the outer sleeve to the elastomer body, which metal rings produce frictional adhesion with the outer sleeve. To increase the frictional adhesion, a metal wire mesh is inserted in the elastomer body. To produce radial play, a free space is provided between the flanges and the inner core. Said bushing likewise has no play in the axial direction, such that the task of providing said axial play must be performed by an expensive bracket.

It is the object of the present invention to specify an elastic bushing of the type specified in the introduction, which elastic bushing is cheap to produce and at the same time provides a degree of play in the axial and radial directions.

Said object is achieved, in the case of a bushing of the type specified in the introduction, in that the inner core has at least one recess formed therein in the axial direction, in that the at least one limiting element is inserted in a positively locking manner into the recess, in that the limiting element is spaced apart from the end region in the axial direction, and in that the end region limits the axial movement of the inner core.

As a result of the axial spacing between the limiting element and the end region and the radial spacing between the limiting element and the outer sleeve, the elastic bushing according to the invention has play in the axial direction and in the radial direction. In this way, separate parts for performing these functions are made superfluous. Consequently, the bearing according to the invention constitutes a cheaper solution than previous elastic bearings. Furthermore, the recesses in the core ensure that the limiting elements are received in a positively locking fashion, such that during the assembly of the elastic bushing, advantageous fixing of the limiting elements to the inner core takes place, and said limiting elements therefore do not slip. Furthermore, the elastic bearing according to the invention has a compact design.

It is advantageous for in each case one limiting element to be arranged on the opposite end sides of the inner core. The bushing therefore has play in all spatial directions.

In a further advantageous refinement, the inner core has four recesses which extend continuously from one end side to the other end side in the axial direction, wherein the recesses are arranged approximately at an angle of 90° with respect to one another.

The limiting element advantageously has four webs which can be inserted in a positively locking manner into the recess of the inner core. Precise positioning of the limiting element on the inner core is ensured in this way.

It is advantageous if there is provided on the inner core a shoulder in which a corresponding annular shoulder of the limiting element engages. As a result, after being mounted, the limiting element is fixed to the inner core such that radial displacement is no longer possible, thereby ensuring that the elastic bushing is easy to handle during the bending of the end regions of the outer sleeve. Furthermore, the two shoulders serve as a stop for the limiting element during the insertion thereof into the inner core.

In a further advantageous refinement, a free space is provided in the axial and/or radial direction between the delimiting element and the elastomer layer. In this way, progressive limitation can be attained because, during an axial or radial or axial and radial movement, the limiting element initially abuts against the elastomer layer, and is subjected to corresponding damping in accordance with the thickness of said layer and the material properties thereof. Consequently, the driving characteristics can be set not only by means of the play present in the axial and radial directions, but rather also by means of the elastomer layer provided between the limiting element and the outer sleeve or the end region.

There is advantageously formed in the inner core an opening into which a flat rod can be pressed. By means of the flat rod, the elastic bushing can be fastened for example to the vehicle body.

The inner core is advantageously produced from an extruded profile cut to length, in particular from aluminum. The elastic bushing therefore has a low overall weight.

In a further advantageous refinement, the limiting element is produced from plastic. A cheap limiting element is provided in this way.

The invention also relates to a method for producing an elastic bushing, which method comprises the following steps. Firstly, an inner core and an outer sleeve are extruded. Subsequently, an elastomer layer is inserted between the inner core and the outer sleeve and is vulcanized. Thereafter, two limiting elements are attached to in each case one end side of the inner core, wherein webs of the limiting element are inserted into recesses of the inner core. Subsequently, the outer sleeve is bent at its opposite ends.

The invention will be explained in more detail below on the basis of an exemplary embodiment illustrated in the drawings, in which:

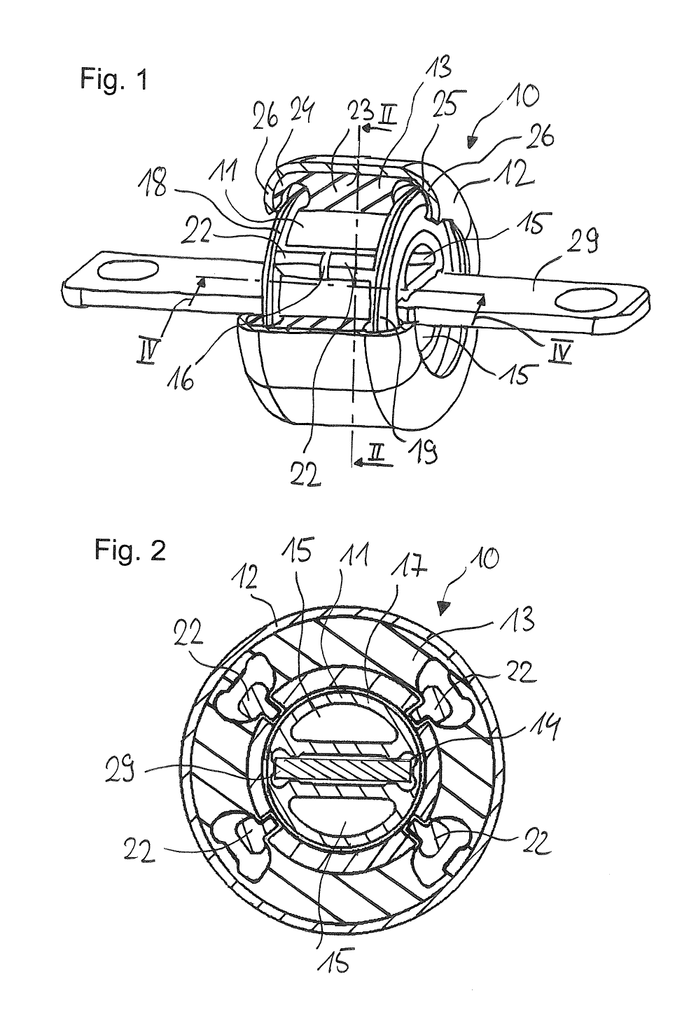

FIG. 1 shows a perspective, partially sectional view of the bearing according to the invention;

FIG. 2 shows a cross section through the bearing according to the invention along the line II-II in FIG. 1;

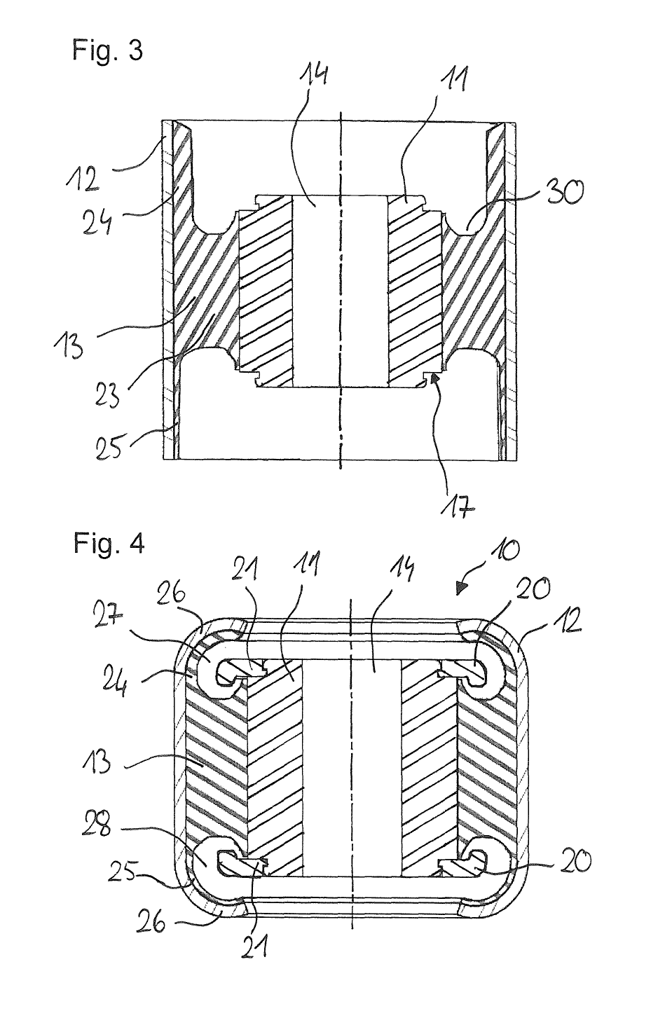

FIG. 3 shows a horizontal section through the bearing according to the invention directly after the vulcanization production step;

FIG. 4 shows a horizontal section through the bearing according to the invention, without a flat rod, along the line IV-IV in FIG. 1, and

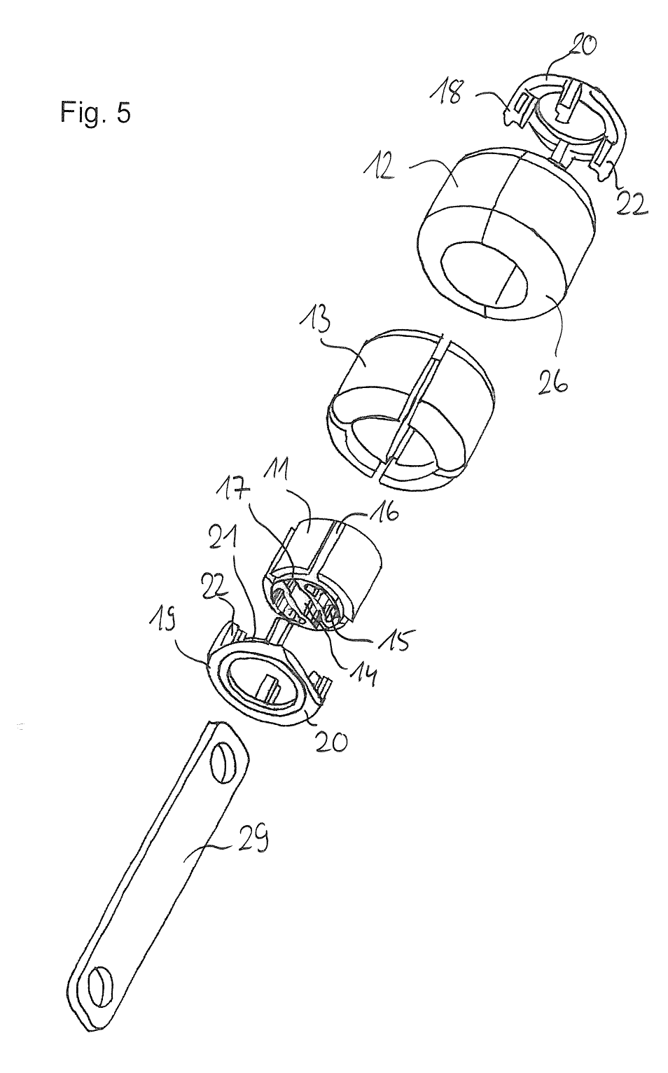

FIG. 5 shows a perspective view of the individual elements of the bearing according to the invention.

FIG. 1 shows an elastic bushing 10 for a twist beam rear axle. The bushing 10 has an inner core 11 and an outer sleeve 12. The inner core 11 and the outer sleeve 12 are arranged concentrically with respect to one another and are connected to one another by means of an elastomer layer 13 inserted between the two sleeves 11, 12.

In FIGS. 1 to 5, the inner core 11 has a through opening 14 and two openings 15 which are arranged parallel to the through opening 14 and which, like the through opening 14, are designed so as to extend continuously from one end side to the other end side of the inner core 11. As illustrated in FIG. 5, four recesses 16 are formed in the inner core 11, which recesses run continuously in the axial direction from one end side of the inner core 11 to the other end side and are arranged approximately at an angle of 90° with respect to one another. Furthermore, the inner core 11 has a shoulder 17.

As is illustrated in FIG. 1, the elastic bushing 10 comprises a first limiting element 18 and a second limiting element 19. As per FIG. 5, the limiting elements 18, 19 have an annular portion 20, which has an annular shoulder 21, and four approximately T-shaped webs 22 which project from the annular portion 20. The limiting elements 18, 19 are produced from plastic.

As per FIGS. 2 and 3, the outer sleeve 12 is formed as a thin-walled tube, wherein the outer sleeve 12 is longer than the inner core 11.

To produce the bushing 10, firstly the inner core 11 is extruded and cut to the desired length. The outer sleeve 12 is likewise extruded and cut to the desired length. Both the inner core 11 and also the outer sleeve 12 are produced from a metallic material, in particular aluminum. The inner core 11 and the outer sleeve 12 are subsequently placed into a vulcanization mold such that they are arranged concentrically with respect to one another. An elastomer layer 13 is subsequently injected, wherein the recesses 16 are kept free from the elastomer layer 13, and said elastomer layer is finally vulcanized so as to yield a cohesive connection of the elastomer layer 13 to the inner core 11 and to the outer sleeve 12. As can be seen from FIG. 3, the elastomer layer 13 comprises a first portion 23, a second portion 24 and a third portion 25. The first portion 23 connects the inner core 11 to the outer sleeve 12 and has two encircling indentations 30. The second portion 24 and the third portion 25 extend in opposite directions away from the first portion 23 in the direction of the end sides of the outer sleeve 12, wherein said portions run along the inner side of the outer sleeve 12. The second portion 24 is thicker than the third portion 25. It is however also conceivable for the third portion 25 to be thicker than the second portion 24. It would furthermore also be conceivable for both portions 24, 25 to be of equal thickness.

As per FIGS. 4 and 5, after the vulcanization of the elastomer layer 13, the limiting elements 18, 19 are attached in each case to the end sides of the inner core 11. For this purpose, the webs 22 of the limiting elements 18, 19 are pushed into the recesses 16, wherein the webs 22 are received in a positively locking manner in the recesses 16, as illustrated in FIG. 2. Furthermore, the annular shoulder 21 of the annular portion 20 engages into the shoulder 17 of the inner core 11, such that the limiting elements 18, 19 are fixed radially.

After the attachment of the limiting elements 18, 19 to the respective end sides of the inner core 11, each end of the outer sleeve 12 is bent inward approximately at right angles in the direction of the inner core 11, so as to form an end region 26. As illustrated in FIGS. 2 and 4, a first free space 27 is hereby formed between the first limiting element 18, the outer sleeve 12 and the end region 26, and between the first limiting element 18 and the second portion 24. A second free space 28 is formed between the second limiting element 19, the outer sleeve 12 and the end region 26, and between the second limiting element 19 and the third portion 25. The size of the free spaces 27, 28 is dependent on the thickness of the first portion 24 and of the second portion 25. As illustrated in FIG. 2, free spaces are likewise formed between the webs 22 and the elastomer layer 13. The two free spaces 27, 28 and the free spaces between the webs 22 and the elastomer layer 13 each permit a movement of the inner core 11 in the radial or axial direction, or a combined movement in the radial and axial direction, of the inner core 11.

As per FIG. 4, the end region 26 serves as a stop for the limiting element 18, 19 in the axial direction. The outer sleeve 12 serves as a stop in the radial direction. Owing to the elastomer layer situated between the limiting elements 18, 19 and the outer sleeve 12 or the end region 26, which elastomer layer is formed by the portions 24, 25, progressive limitation during the abutment of the limiting elements 18, 19 against the portions 24, 25 can be realized. Different stiffnesses can be attained depending on the thickness of the portions 24, 25 and depending on the material properties.

To fix the bushing 10 to a vehicle body (not illustrated in any more detail), a flat rod 29 is pressed into the through opening 14, as illustrated in FIGS. 1 and 5, wherein the flat rod 29 is connected by means of its openings, illustrated in FIGS. 1 and 5, to the vehicle body. The elastic bushing 10 is pressed into a receiving lug.

The elastic bushing 10 is characterized by its play in the axial and radial directions, wherein no separate parts which are expensive and complex to produce are required for this purpose. This is made possible firstly by the limiting elements 18, 19 and secondly by the outer sleeve 12 and the bent end regions 26 of the outer sleeve 12. Owing to the elastomer layer 13 between the limiting elements 18, 19 and the outer sleeve 12 or the end regions 26, it is additionally possible for progressive limitation during the abutment of the limiting elements 18, 19 to be realized, such that the driving characteristics can be additionally influenced in this way. Furthermore, the elastic bushing is characterized by its compact design and cheap production. Furthermore, the recesses 16 in the inner core 11 permit precise positioning of the limiting elements 18, 19 on the inner core 11, and easy handling thereof, during assembly.

### LIST OF REFERENCE NUMERALS

10 Elastic bushing
11 Inner core
12 Outer sleeve
13 Elastomer layer
14 Through opening
15 Opening
16 Recess
17 Shoulder
18 First limiting element
19 Second limiting element
20 Annular portion
21 Annular shoulder
22 Web
23 First portion
24 Second portion
25 Third portion
26 Bent end region
27 First free space
28 Second free space
30 Indentations

1-10. (canceled)

11. An elastic bushing, comprising:
an inner core and an outer sleeve arranged concentrically with respect to one another and defining an axial direction and a radial direction;
an elastomer layer connecting said inner core and said outer sleeve to one another;
a limiting element disposed between said inner core and said outer sleeve for limiting a movement of said inner core in the radial direction;
said outer sleeve having an inwardly bent end region limiting a movement of said inner core in the axial direction;
said inner core having at least one recess formed therein extending in the axial direction; and
said limiting element being inserted into said recess in a positively locking manner and being spaced apart from said inwardly bent end region in the axial direction.

12. The elastic bushing according to claim 11, configured as a twist beam rear axle bushing.

13. The elastic bushing according to claim 11, wherein said limiting element is one of two limiting elements respectively arranged on mutually opposite end sides of said inner core.

14. The elastic bushing according to claim 11, wherein said recess is one of four recesses formed in said inner core and extending continuously from one end side to the other end side in the axial direction, and wherein said four recesses are arranged substantially at an angle of 90° with respect to one another circumferentially around said inner core.

15. The elastic bushing according to claim 14, wherein said limiting element comprises four webs each to be inserted in a positively locking manner into a respective said recess of said inner core.

16. The elastic bushing according to claim 11, wherein said inner core is formed with a shoulder and said limiting element is formed with a corresponding annular shoulder engaging with said shoulder of said inner core.

17. The elastic bushing according to claim 11, wherein a free space is formed in one or both of the axial direction or the radial direction between said limiting element and said elastomer layer.

18. The elastic bushing according to claim 11, wherein said inner core is formed with an opening configured to receive therein a flat rod.

19. The elastic bushing according to claim 11, wherein said inner core is formed of an extruded profile cut to length.

20. The elastic bushing according to claim 19, wherein said inner core is formed of extruded aluminum.

21. The elastic bushing according to claim 11, wherein said limiting element is produced of plastic.

22. A method for producing an elastic bushing according to claim 11, the method which comprises the following steps:
extruding an inner core and an outer sleeve;
inserting an elastomer layer between the inner core and the outer sleeve and vulcanizing the elastomer layer;
attaching two limiting elements to in each case one end side of the inner core, and thereby inserting webs of the limiting elements into recesses formed in the inner core; and
bending the outer sleeve at opposite ends thereof, to thereby produce the elastic bushing according to claim 11.
